(19) United States
(12) Patent Application Publication
(10) Pub. No.: US 2011/0139266 A1
(43) Pub. Date: Jun. 16, 2011

(54) ADJUSTABLE PLUGS FOR FLUID FLOW-SPLIT ACCURACY

(76) Inventors: Tomas R. Leutwiler, Enfield, CT (US); Glenn Gradischer, Canton, CT (US); Anthony Towne, Windsor, CT (US); Richard H. Bostiga, Ellington, CT (US)

(21) Appl. No.: 12/635,878

(22) Filed: Dec. 11, 2009

(51) Int. Cl. G05D 11/00; G01F 25/00

(52) U.S. Cl. 137/98; 137/87.01; 137/99; 73/1.16

(57) ABSTRACT

A flow splitter for accurately dividing fluid flow into different outlets includes a splitter valve and a calibration member. The calibration member blocks a portion of fluid flow to reduce differences in the divided fluid flows.

### BACKGROUND

This disclosure generally relates to a fluid flow splitter device that provides fuel to two or more outlet ports. More particularly, this disclosure relates to a fluid flow-splitter that provides a desired accuracy of fluid flow division between two or more ports.

A fuel system for providing fuel flow to an engine, combustor or other energy conversion device can require essentially identical fuel flows to different locations. Such a requirement is measured and specified as a maximum difference between flow rates at each of the outlet locations. Dividing fuel flows between different outlets is often provided by a flow splitter device that includes an electrically or hydraulically actuated valve. The valves are provided to accommodate the desired split of flows over a range of fuel flow rates. The desired accuracy requirements are becoming more stringent and therefore it is desirable to design and develop devices and methods that improve the accuracy in dividing fluid flows among several outlets.

### SUMMARY

A fuel delivery system is disclosed and includes a flow splitter that divides fuel flow into two substantially equal flows. The flow splitter includes a splitter valve that divides fuel flow from an inlet into two separate flows that exit through a first outlet and a second outlet. A calibration member is disposed in the first outlet and provides adjustment of fuel flow such that the difference between fuel flows can be reduced and/or eliminated.

These and other features disclosed herein can be best understood from the following specification and drawings, the following of which is a brief description.

### BRIEF DESCRIPTION OF THE DRAWINGS

FIG. 1 is a schematic representation of an example fuel system for a gas turbine engine.

FIG. 2 is a cross-sectional view of an example flow splitter.

FIG. 3A is a cross-section of the example calibration member in a retracted position.

FIG. 3B is a cross-section of the example calibration member in an extended position.

FIG. 4 is a cross-section of the example calibration member mounted within an outlet.

FIG. 5 is a cross-section of a fixed length calibration plug.

FIG. 6 is a schematic view of a plurality of fixed calibration plugs.

FIG. 7 is a cross-section of an example flow splitter including the fixed length calibration plug.

FIG. 8 is an enlarged cross-section of the example fixed length calibration plug within the flow splitter.

### DETAILED DESCRIPTION

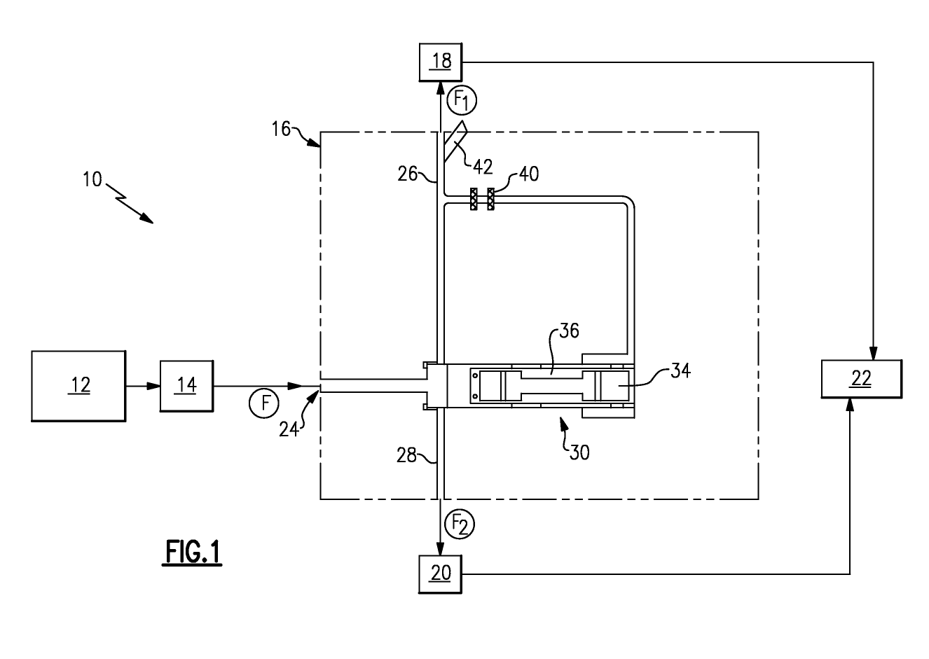

Referring to FIG. 1, a fuel delivery system 10 is schematically shown and includes a fuel controller 14 that receives fuel from a fuel tank 12 and expels a fuel flow to a flow splitter 16. The flow splitter 16 divides fuel flow F into two substantially equal fuels flows F1 and F2. The flow splitter 16 includes a splitter valve 30 that divides fuel flow from an inlet 24 into two separate flows that exit through a first outlet 26 and a second outlet 28. A valve member 34 is disposed within a cavity 36 of the splitter valve 30 to provide the desired divided flow. An orifice 40 is disposed within a supply line that provides flow to a portion of the chamber 36. The orifice 40 controls a relative pressure within the cavity 36 to provide the desired control of the fuel flows F1 and F2. Although an example splitter valve 30 is disclosed, other configurations of valves could be utilized with this disclosure.

A calibration member 42 is disposed in the first outlet 26 and provides adjustment of fuel flow F1 such that the difference between fuel flows F1 and F2 can be reduced and/or eliminated. Fuel from the first outlet 26 is directed to a first manifold 18. Fuel flow from the second outlet 28 is directed to a second manifold 20. The first and second manifolds 18, 20 in turn direct fuel to an energy conversion device 22, such as a combustor for a gas turbine engine or other combustion engine.

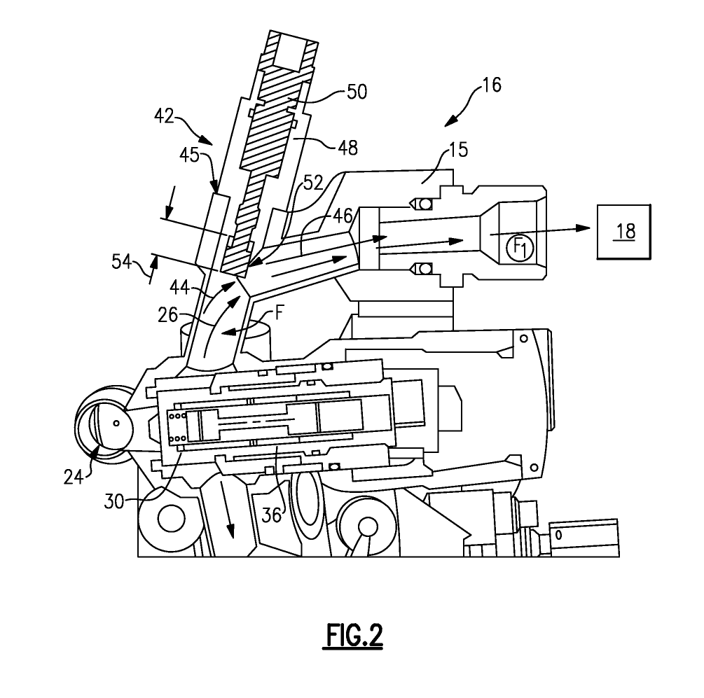

Referring to FIG. 2, the example flow splitter 16 comprises a housing 15 within which are formed the inlet 24, the outlets 26, 28 and a cavity 36 for the splitter valve 30. The features of the housing 15 can be formed by casting, machining, and/or any other fabrication process capable of providing for multiple interconnected passages.

The example outlets 26, 28 are formed as a first portion 44 that is in communication with the cavity 36 for the splitter valve 30. The first portion 44 includes an open end 45 within which the calibration member 42 is installed. The first portion 44 of the first outlet 26 intersects a second portion 46 that communicates fuel flow out of the housing 15 and to the first manifold 18.

The calibration member 42 includes a fixed portion 48 that is threaded into the opening 45 and supports a movable adjusting member 50. The adjusting member 50 extends into first portion 44 at the intersection with the second portion 46 to block a portion of fluid flow F. The end of the adjusting member 50 includes a restriction 52 that extends a distance 54 into the first outlet 26. The distance 54 is variable by rotating the adjusting member 50. The shape of the restriction 52 provides for blocking a sufficient amount of fuel flow to match flows between the outlets 26 and 28. Substantially equal fuel flows are desired to the first and second manifolds 18, 20 to provide the desired proper operation of the energy conversion device 22.

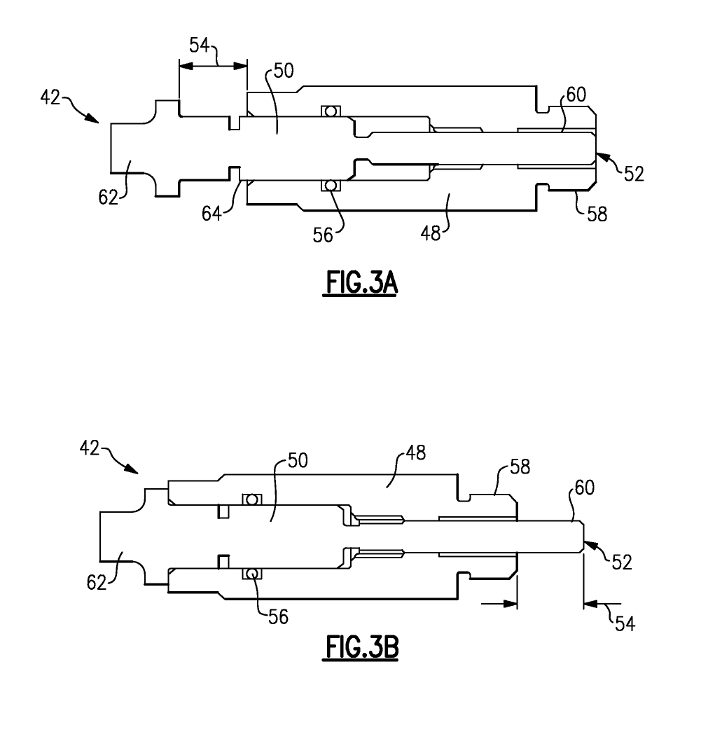

Referring to FIG. 3A, the example calibration member 42 is shown in a retracted position with the restriction end 52 disposed within the fixed portion 48. The fixed portion includes external threads 58 that provides for mounting into the open end 45 of the housing 15. The adjusting member 50 includes threads 60 that engage corresponding internal threads of the fixed portion 48. A seal 56 is provided between the adjusting portion 50 and internal surface of the fixed portion for preventing leakage through the calibration member 42.

The adjusting member 50 includes a groove 64 that provides an indication of the length 54 in which the restriction end 52 has been retracted. The groove 64 also provides a visual indication of the narrowed threaded portion relative to the seal 56 within the fixed portion 48. The visual indication alerts that the narrowed portion of the adjusting member 50 is approaching the seal 56 to prevent errant dislodgement. A head portion 62 of the adjusting member 50 includes a shape that corresponds with a tool for rotating the adjusting member 50 from the retracted position shown in FIG. 3A.

Referring to FIG. 3B, the adjusting member 50 is shown in an extended position where the threaded portion 60 is extended a length 54 from the fixed member 48. The head portion 62 includes a flange that limits extension of the adjusting member 50 from the fixed portion 48.

Referring to FIG. 4, in operation, the calibration member 42 is installed with the opening 45 such that the restriction end 52 is disposed within the first portion 44 of the first outlet 26. The restriction end 52 extends the length 54 into the flow stream F to block a portion of the fluid flow. The fluid flow F1 is measured and compared to fluid flow F2 from the second outlet 28. In the disclosed example, it is desired to match the flows F1 and F2 for differing flow rates. The splitter valve 30 divides the incoming fluid flow F into the two flows F1 and F2. However, the splitter valve 30 does not provide the desired accuracy in flow rates. Therefore, the calibration member 42 is provided in the first outlet 26 to provide a fine final adjustment that provides for matched fluid flows F1 and F2.

The flow matching process begins with the initial installation of the calibration member 42 into the opening 45. Fluid flow is driven through the flow splitter 16 and the outgoing flows F1 and F2 are measured relative to each other. The adjusting member 50 is then extended into the first outlet 26 to block a portion of the fluid flow until the flows F1 and F2 are substantially the same, within an acceptable tolerance range. In the illustrated example, the restriction 52 is disposed at the intersection of the first portion 44 with the second portion 46. However, the calibration member 42, and thereby the restriction 52 could be placed at other locations with the first outlet 26 as would be consistent with matching flows from the outlets 26 and 28.

Referring to FIG. 5, once the flows F1 and F2 are satisfactorily matched, a fixed plug 66 is installed in place of the calibration member 42. As appreciated, the calibration member 42 could remain in place and remains a permanent part of the flow splitter 16. Replacement of the adjustable calibration member 42 with the fixed plug 66 prevents tampering. The example fixed plug 66 includes a restriction of the fixed length 54 that is matched to the length 54 determined to provide the desired flow matching between the outgoing flows F1 and F2. That is, once the proper length 54 is determined that provides for the desired flow matching of the flows F1 and F2, a fixed plug 66 including the same length 54 is installed and the desired flow rates verified. The fixed plug 66 provides the desired flow matching between outgoing flows F1 and F2.

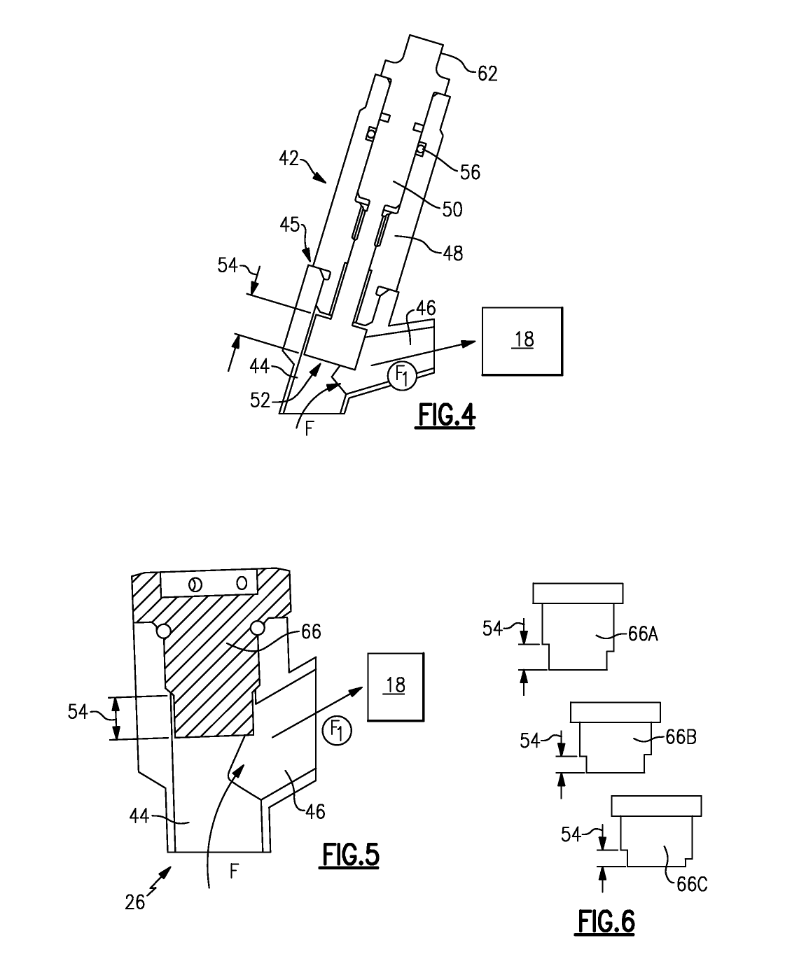

Referring to FIG. 6 with continued reference to FIG. 5, a plurality of plugs 66A, 66B, 66C are provided and selected based on the length 54 determined through calibration with the calibration member 42. Each of the plugs 66A, 66B, and 66C include different lengths 54. Once the length is determined that provides matching flows F1 and F2, one of the plurality of fixed plugs 66A, 66B, and 66C that corresponds to that length is selected and installed within the opening 45 to block a portion of the fluid flow F.

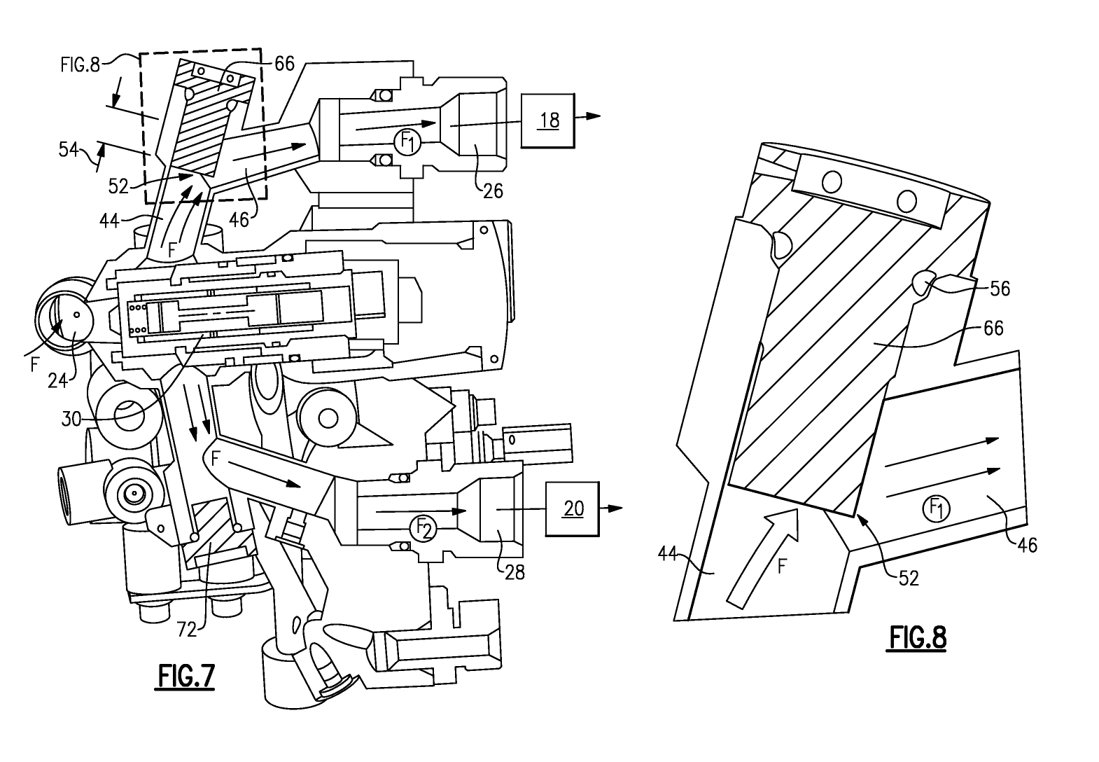

Referring to FIGS. 7 and 8, a calibrated flow splitter 16 is shown and includes the fixed plug 66 of a length 54 within the opening 45. The second outlet 28 includes a plug 72 that does not block or otherwise restrict flow. The example plug 72 is provided to plug the opening in the outlet 28 that is created during the machining process and formation of the various passages and cavities of the flow splitter 16.

The calibrated flow splitter 16 receives flow F from the flow controller 14. Flow F is divided by the splitter valve 30 into passages comprising the first and second outlets 26, 28. The fixed plug 66 extends into the first outlet 26 a length that blocks a portion of the fluid flow such that the outgoing flows F1 and F2 are within a desired range. In the example, the flows F1 and F2 are matched; however other relationships and ratios between flows are within the contemplation of this invention.

Accordingly, the example flow splitter 16 is calibrated to provide a fine adjustment in matching fluid flows beyond the capability of the splitter valve 30. Moreover, the example flow splitter 16 provides such matched flows without the need for identically machining each of the outlets 26 and 28.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A fluid flow splitter assembly comprising:
an inlet receiving a fluid flow;
a first outlet in communication with the inlet;
a second outlet in communication with the inlet;
a valve in communication with the inlet that divides fluid flow between the first outlet and the second outlet; and
a calibration member blocking a portion of fluid flow through one of the first and second outlets for adjusting relative fluid flow through the first and second outlets.

2. The assembly as recited in claim 1, wherein the calibration member comprises a plug extending a desired length into the fluid flow through the first and second outlets.

3. The assembly as recited in claim 2, wherein the length of the plug extending into the fluid flow is variable for blocking a desired amount of fluid flow.

4. The assembly as recited in claim 3, wherein calibration member comprises a fixed portion received at least partially within one of the first and second outlets and an adjustment member movably mounted within the fixed portion for adjusting the length of the plug extending into the fluid flow.

5. The assembly as recited in claim 4, wherein the fixed portion is threadably received within an opening of one of the first and second outlets and the adjustment member is threadably received within the fixed member.

6. The assembly as recited in claim 5, including a seal disposed between the adjustment member and the fixed member.

7. The assembly as recited in claim 1, wherein each of the first and second outlets comprises a conduit including a first portion intersecting a second portion, with the first portion terminating in an open end past the intersection with the calibration member received with the open end of the first portion.

8. A fuel system for an aircraft comprising:
a flow control receiving fuel flow from a fuel storage tank; and
a flow splitter including an inlet that receives fuel flow from the fuel control, first and second outlets in communication with the inlet for directing fuel to an energy conversion device, and a calibration member blocking a portion of fluid flow through one of the first and second outlets such that fuel flow from the inlet is divided according to a desired ratio between the first and second outlets.

9. The fuel system as recited in claim 8, wherein the calibration member blocks a portion of the fuel flow through one of the first and second outlets such that the fuel flow is divided substantially equally between the first and second outlets.

10. The fuel system as recited in claim 9, wherein the calibration member includes a plug portion extending a distance into the fuel flow through one of the first and second outlets.

11. The fuel system as recited in claim 10, wherein the calibration member comprises a fixed portion and the plug portion is movable relative to the fixed portion such that a length in which the plug portion extends into the fuel flow is variable.

12. The fuel system as recited in claim 8, including a splitter valve that divides fuel flow from the inlet between the first and second outlets.

13. A method of calibrating fuel flows through a fluid flow splitter, the method comprising the steps of:
flowing fluid through a flow splitter device including an inlet and at least two outlets;
measuring fluid flow through each of the at least two outlets;
comparing the fluid flow through each of the at least two outlets to a desired ratio of fuel flow; and
adjusting a calibration plug disposed in one of the at least two outlets to block a portion of fuel flow through that outlet to attain the desired ratio of fuel flow between the at least two outlets.

14. The method of calibrating fuel flows as recited in claim 13, wherein the adjusting step comprises varying a length in which the calibration plug extends into outlet.

15. The method of calibrating fuel flows as recited in claim 14, including the step of determining a length in which the calibration plug extends into the outlet and substituting a fixed plug of the determined length for the calibration plug.

16. The method of calibrating fuel flows as recited in claim 15, including the step of providing a plurality of fixed plugs of varying lengths and substituting a fixed plug of the determined length for the calibration plug for blocking a portion of fuel flow through one of the at least two outlets.
